(19) United States
(12) Patent Application Publication
(10) Pub. No.: US 2006/0228967 A1
(43) Pub. Date: Oct. 12, 2006

(54) Sliver knitted thermal substrate

(75) Inventor: Harry F. Gladfelter, Kimberton, PA (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul Wordwide, Inc.

(21) Appl. No.: 11/402,235

(22) Filed: Apr. 11, 2006

Related U.S. Application Data
(60) Provisional application No. 60/670,439, filed on Apr. 12, 2005.

(51) Int. Cl. D03D 15/00; B32B 15/14; D04B 21/00; D04H 13/00

(52) U.S. Cl. 442/228; 442/316; 442/304; 442/376; 442/377; 442/378; 442/181; 442/232

(57) ABSTRACT

The invention provides a substrate for inhibiting heat transfer. The substrate includes a textile base layer formed with filamentary members. The substrate also includes a sliver layer having a plurality of staple fibers interlaced with the filamentary members of the textile base layer. The staple fibers of the sliver layer are oriented substantially perpendicular to the base layer. The substrate also includes at least one reflective layer attached to one of the base layer and the sliver layer.

### CROSS-REFERENCE TO RELATED APPLICATIONS

This application claims the benefit of U.S. Provisional Patent Application Ser. No. 60/670,439 for a SLIVER KNITTED THERMAL SUBSTRATE, filed on Apr. 12, 2005, which is hereby incorporated by reference in its entirety.

### BACKGROUND OF THE INVENTION

1. Field of the Invention

The invention concerns textile substrates for inhibiting heat transfer.

2. Description of Related Art

Substrates used as heat shields should substantially inhibit radiant transfer, or conductive transfer, or both depending on the operating environment of the substrate. Heat shield substrates can be formed of a non-woven layer and a reflective layer supported by the non-woven layer. The non-woven layer can be formed by compressing randomly oriented fibers one on top of another in the manner of a felt material. The fibers are randomly oriented substantially in the plane of the substrate. The reflective layer may be a metal foil such as aluminum, copper, silver or gold having good optical reflective characteristics.

### SUMMARY OF THE INVENTION

The invention provides a substrate for inhibiting heat transfer. The substrate includes a textile base layer formed with filamentary members. The substrate also includes a sliver layer having a plurality of staple fibers interlaced with the filamentary members of the textile base layer. The staple fibers of the sliver layer are oriented substantially perpendicular to the base layer. The substrate also includes at least one reflective layer attached to one of the base layer and the sliver layer.

### BRIEF DESCRIPTION OF THE DRAWINGS

Advantages of the present invention will become more readily appreciated when considered in connection with the following detailed description and appended drawings, wherein:

FIG. 1 is a perspective view of a first exemplary embodiment of the invention with a portion of a reflective layer removed to better show a sliver layer;

FIG. 2 is a cross-sectional view of a second embodiment of the invention having two reflective layers;

FIG. 3 is a perspective view of a third exemplary embodiment of the invention with a portion of a reflective layer removed to better show a textile layer;

FIG. 4 is a schematic view of a fourth exemplary embodiment of the invention wherein the sliver layer includes staple fibers captured by the textile base layer; and

FIG. 5 is a schematic view of a fifth exemplary embodiment of the invention wherein the sliver layer includes staple fibers having different lengths.

### DETAILED DESCRIPTION OF THE PREFERRED EMBODIMENT

A plurality of different embodiments of the invention is shown in the Figures of the application. Similar features are shown in the various embodiments of the invention. Similar features have been numbered with a common reference numeral and have been differentiated by an alphabetic designation. Also, to enhance consistency, features in any particular drawing share the same alphabetic designation even if the feature is shown in less than all embodiments. Similar features are structured similarly, operate similarly, and/or have the same function unless otherwise indicated by the drawings or this specification. Furthermore, particular features of one embodiment can replace corresponding features in another embodiment unless otherwise indicated by the drawings or this specification.

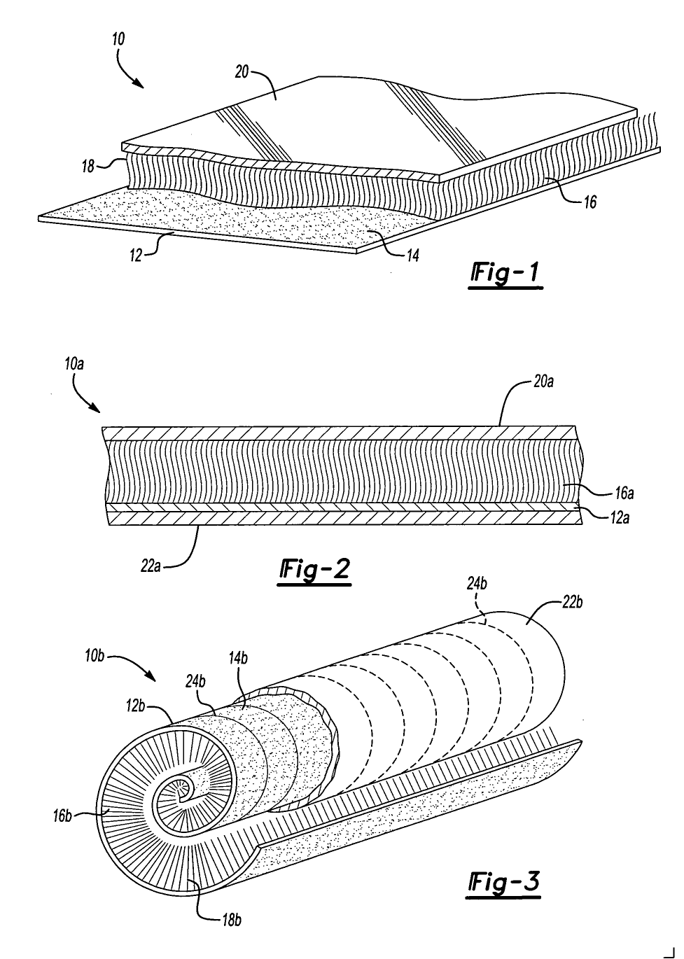

In a first exemplary embodiment of the invention, shown in FIG. 1, a substrate 10 can inhibit both radiant and conductive heat transfer. The substrate 10 has a textile base layer 12 formed of knitted filamentary members 14. Although weft knitting is preferred, other knit stitches can be applied to practice the invention in other embodiments.

The substrate 10 also includes a sliver layer 16 having a first plurality of staple fibers 18 interlaced with the filamentary members 14 of the textile base layer 12. The staple fibers 18 are oriented substantially perpendicular to said base layer 12. The exemplary sliver layer 16 comprises untwisted strands of staple fibers 18 produced by a carding process. The staple fibers 18 are preferably between about 1 to 2 inches long and have a denier between about 4 and 10. The staple fibers 18 comprising the sliver layer 16 are engaged by the needles of the knitting machine and interlaced with the filamentary members 14 during knitting of the textile base layer 12 in a manner similar to the manufacture of pile carpeting. The staple fibers 18 are also carded during knitting to orient them substantially perpendicular to the base layer 12. The staple fibers 18 can be trimmed in length to produce a substrate of a desired thickness.

The substrate 10 also includes a reflective layer 20 adhered to one of the textile base layer 12 or the sliver layer 16. In the first exemplary embodiment of the invention, the reflective layer 20 is attached to the sliver layer 16. The exemplary reflective layer 20 is formed, at least in part, from metallic foil such as aluminum, copper or gold which has excellent radiant heat reflective characteristics. Other foil examples include stainless steel and galvanized steel.

The textile base layer 12 provides the substrate 10 with a robust foundation that supports the sliver layer 16 and the reflective layer 20. The reflective layer 20 substantially blocks radiant heat transfer through the substrate and, due to the substantial amount of air trapped between the textile base layer 12 and the reflective layer 20 by the sliver layer 16, conductive heat transfer through the substrate 10 is inhibited as well. The sliver layer 16 also displays excellent damping characteristics due to the tenuous interconnected nature of the staple fibers 18. The substrate 10 therefore is also effective at insulating with respect to acoustic and structure borne vibrations.

The textile base layer 12 is preferably knitted from multi-filament yarns which enhance flexibility, allowing the substrate 10 to readily conform to virtually any shape and provide adequate coverage to items requiring thermal protection. The staple fibers 18 of the sliver layer 16 are preferably back coated to hold the staple fibers 18 in place. If it is desired that the substrate 10 be relatively stiffer, sizing agents may be applied to the textile base layer 12. Alternately, for increased stiffness, monofilaments may also be used to form the textile base layer 12. Preferred materials for forming the textile base layer 12 include yarns or monofilaments, with either layer being of polymers such as polyester, aramids including Kevlar® and nylon, wire, silver plated nylon, and/or copper/nickel-plated polyester. For particularly high temperature applications, mineral fibers such as glass, silica and basalt may be used to form the textile base layer 12. The materials forming the textile base layer 12 may also be chosen for specific characteristics including, for example, resistance to abrasion, elasticity, tensile strength and electrical conductivity.

The staple fibers 18 forming the sliver layer 16 are preferably comprised of bulky fibers which may be carded and form a fleece-like layer defining air space between the textile base layer 12 and the reflective layer 20. Preferred materials for the sliver layer 16 include polyester, as well as nylon, oxidized polyacrylonitrile such as Panox® or another a long chain synthetic polymer composed of between 35 and 85% acrylonitrile units by weight, carbon, glass, polypropylene or other olefins, metal-plated fibers (e.g., silver on nylon or copper/nickel on polyester) and blends of all of the aforementioned.

In a second exemplary embodiment of the invention, shown in FIG. 2, a substrate 10a includes a first reflective layer 20a attached to a sliver layer 16a and the sliver layer 16a is interlaced with a textile base layer 12a. The substrate 10a also includes a second reflective layer 22 attached to the textile base layer 12a spaced from the sliver layer 16a. The reflective layers 20a, 22a are preferably adhesively bonded to the sliver layer 16a and the base layer 20a, respectively. Other attachment techniques, such as fusing or welding, are also feasible for mutually compatible materials. It may also be desirable to metalize the textile base layer 12a and the sliver layer 16a by techniques such as sputter, plasma and vacuum deposition.

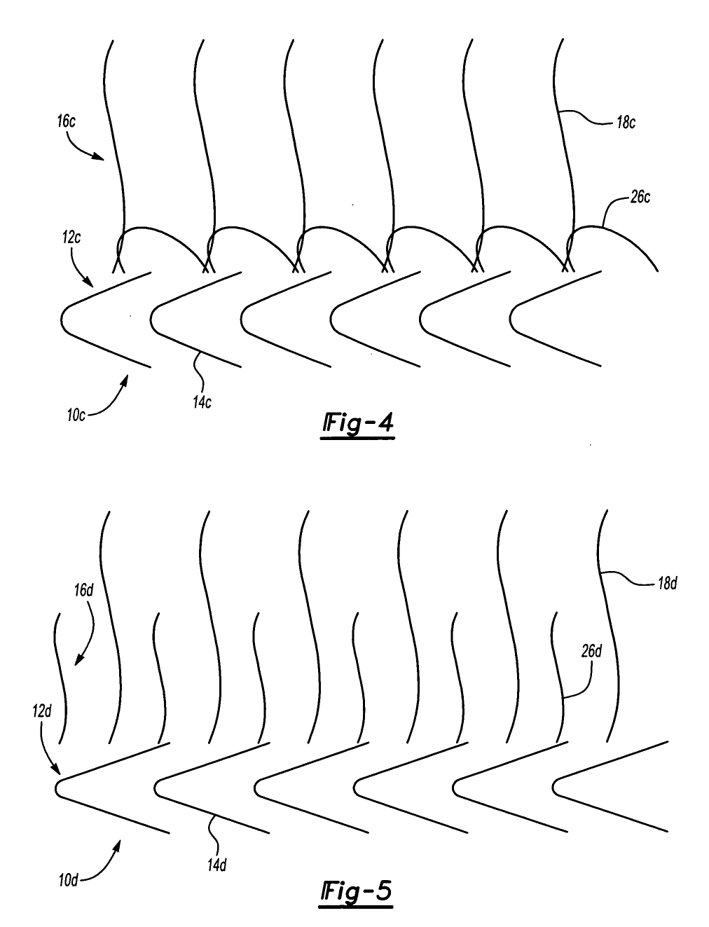

In a third exemplary embodiment of the invention, shown in FIG. 3, a substrate 10b is molded or biased into a particular configuration or shape appropriate to a particular application. The substrate 10b is a tubular sleeve in which a reflective layer 22b is positioned on a textile base layer 12b. A sliver layer 16b with staple fibers 18b faces radially inwardly on the inside surface of the textile base layer 12b. The tubular shape of the substrate 10b is maintained by relatively stiff monofilaments 24b that are laid in the textile base layer 12b during knitting. These monofilaments 24b may then be biased, using heat, chemical or mechanical techniques to resiliently assume a particular shape, such as the spiral overlapping cylindrical shape forming the tubular sleeve. The exemplary monofilaments 24b are arranged in parallel spaced apart relation so as to define the circumference of the tubular sleeve when biased into a curved shape. Other shapes are of course feasible, allowing the substrate 10b to assume a form fitting appearance over a particular component if desired. The tubular sleeve effectively inhibits both radiant and conductive heat transfer to any elongated item positioned within the tubular sleeve of the substrate 10b. The sliver layer 16b additionally provides acoustic and vibrational damping.

Since the substrate may also be knitted as a circular weft knit, it is possible to knit a tube with the sliver pile to the inside. Toughened yarns can then be used for the outside, or the outside can be chemically coated with tough polymers. Also, the sliver can be a mix of heat-formable sliver like CelBond, which, when blended with regular melt fibers, can be formed in a mold with heat and pressure. CelBond is a core/sheath type filament, where the sheath is a lower-melt temperature material that can then be melted to have the filament bond with its neighboring components. Another potential advantage to using CelBond in embodiments of the invention is that, once heated, the sleeve can self-locate with respect to the protected component. Furthermore, once positively located, the sleeve will be less likely to slide along the length of the protected component. The sleeve is more likely to adhere to the protected component. The invention can also take the form of a tubular, seamless knitted sleeve, such that the sliver layer is inside and an abrasion-resistant and/or heat-resistant yarn is to the outside.

In other embodiments of the invention it is also possible, with circular knits, to “stripe,” in which materials and/or material combinations can vary along the length of the sleeve. For example, there can be sections that contain no sliver layer. The sleeve can be cut in these sections to form cuffs. The cuffs prevent the sliver layer from being exposed at the lengthwise ends of the sleeve and/or can denote areas for clamping the sleeve onto the component to be protected. The sliver layer can also vary in material along the length of the sleeve to vary the level of thermal protection along the length of the protected component. U.S. Pat. No. 6,978,643 shows this process and is hereby incorporated by reference.

In other embodiments of the invention, it is also possible to “plate,” in which two or more yarns can be knit together (e.g., in addition to the sliver) such that one yarn is primarily on the outer surface of the finished sleeve and the other is primarily on the inner. For example, polyester and Nomex® yarns can be plated with respect to one another to contain glass sliver inside for a sleeve that will sheathe an exhaust pipe. The polyester, the lowest-temperature-rated material of the three, can be the sleeve's outermost layer, to present a “cool” surface to an automotive technician who may accidentally touch the covered exhaust pipe while working in its vicinity.

In a fourth exemplary embodiment of the invention, shown schematically in FIG. 4, a substrate 10c includes a textile base layer 12c knitted from filamentary members 14c and also includes a sliver layer 16c with a first plurality of staple fibers 18c and a second plurality of staple fibers 26c. The filamentary members 14c of the textile base layer 12c capture the second plurality of staple fibers 26c. The textile base layer 12c can be knit to be formed in layers by knitting a plurality of the staple fibers 26c back into the textile base layer 12c, but allowing the staple fibers 18c to remain as part of the pile extending from the textile base layer 12c. This forms a density gradient in the textile base layer 12c.

In a fifth exemplary embodiment of the invention, shown schematically in FIG. 5, a substrate 10d includes a textile base layer 12d knitted from filamentary members 14d and also includes a sliver layer 16d with a first plurality of staple fibers 18d and a second plurality of staple fibers 26d. The staple fibers 26d can be more heat shrinkable than the staple fibers 18d. The sliver layer 16d can be subjected to heating or ultrasonic radiation to shrink the fibers 26d relative to the staple fibers 18d. After shrinking, the substrate 10d defines a density gradient between the free ends of the staple fibers 18d and the textile base layer 12d.

Many modifications and variations of the present invention are possible in light of the above teachings, including the elimination of the reflective layer. It is, therefore, to be understood that within the scope of the appended claims, the invention may be practiced otherwise than as specifically described.

What is claimed is:

1. A substrate for protecting a component from one of heat transfer and vibration transfer comprising:
a textile base layer formed with filamentary members; and
a sliver layer having a first plurality of staple fibers interlaced with said filamentary members of said textile base layer and oriented substantially perpendicular to said textile base layer.

2. A substrate for inhibiting heat transfer comprising:
a textile base layer formed with filamentary members;
a sliver layer having a first plurality of staple fibers interlaced with said filamentary members of said textile base layer and oriented substantially perpendicular to said textile base layer; and
at least one reflective layer attached to one of said textile base layer and said sliver layer.

3. The substrate according to claim 2 wherein said at least one reflective layer is attached to said first plurality of staple fibers.

4. The substrate according to claim 2 wherein said at least one reflective layer is spaced from said first plurality of staple fibers.

5. The substrate according to claim 2 wherein said first reflective layer includes a metallic foil.

6. The substrate according to claim 2 wherein said at least one reflective layer includes a first reflective layer attached to said first plurality of staple fibers and a second reflective layer attached to said textile base layer.

7. The substrate according to claim 2 wherein said first plurality of staple fibers of said sliver layer have a denier between about 4 and about 10.

8. The substrate according to claim 2 wherein said first plurality of staple fibers of said sliver layer are further defined as being between about one and about two inches long.

9. The substrate according to claim 2 wherein said first plurality of staple fibers are formed, at least in part, from polyester.

10. The substrate of claim 2 wherein said sliver layer further comprises:
a second plurality of staple captured by said textile base layer.

11. The substrate of claim 2 wherein said first plurality of staple fibers are formed from different materials.

12. The substrate of claim 2 wherein at least some of said first plurality of staple fibers are heat shrinkable.

13. The substrate of claim 12 wherein less than all of said first plurality of staple fibers are heat shrinkable.

14. The substrate according to claim 2 wherein said filamentary members are formed from material selected from a group comprising glass, aramids, and polyester.

15. The substrate according to claim 2 wherein said filamentary members comprise multifilament yarns.

16. The substrate according to claim 2 wherein said textile base layer further comprises:
a plurality of monofilaments laid in with said filamentary members, and being biasable into a predetermined shape for forming said textile base layer.

17. The substrate according to claim 2 wherein said textile base layer has a tubular shape.

18. A method for inhibiting heat transfer comprising:
forming a textile base layer with filamentary members;
interlacing a first plurality of staple fibers of a sliver layer with the filamentary members of said textile base layer oriented substantially perpendicular to the textile base layer; and
attaching at least one reflective layer to one of the textile base layer and the sliver layer.

19. The method of claim 18 further comprising the step of:
defining a density gradient between free ends of the staple fibers and the textile base layer.

20. The method of claim 18 further comprising the step of:
resiliently biasing the textile base layer into a predetermined shape.

21. The method of claim 18 further comprising the step of:
shrinking less than all the staple fibers after formation of the sliver layer.
